(19) United States
(12) Patent Application Publication
(10) Pub. No.: US 2015/0120405 A1
(43) Pub. Date: Apr. 30, 2015

(54) SYSTEM AND METHOD FOR REAL TIME PROMOTION AND CUSTOMER ENGAGEMENT THROUGH LOCAL EVENTS

(71) Applicant: Ted Kavana, Waxhaw, NC (US)

(72) Inventor: Ted Kavana, Waxhaw, NC (US)

(21) Appl. No.: 14/061,944

(22) Filed: Oct. 24, 2013

(51) Int. Cl. G06Q 30/02

(52) U.S. Cl. CPC G06Q 30/0252; G06Q 30/0259
USPC 705/14.5

(57) ABSTRACT

The present invention provides a computer or web-based system designed for collecting and updating information related to beverages, food, products, and events in real time and providing a consumer interactive system for promoting such beverages, food, products, and events in real time at a local level. More particularly, the invention relates to a system and method for providing a web and mobile based platform to promote adult or alcoholic beverages, non-alcohol beverages, products & events real-time at a local level.

### BACKGROUND OF THE INVENTION

The present invention relates generally to a system and method for collecting information related to beverages, food, products, and events in real time and providing a way to promote such items at a local level.

### SUMMARY OF THE INVENTION

This summary is provided to introduce concepts in a simplified form that are further described in the detailed description of the invention. This summary is not intended to identify key or essential inventive concepts of the claimed subject matter, nor is it intended for determining the scope of the claimed subject matter.

The present invention provides a computer or web-based system designed for collecting and updating information related to beverages, food, products, and events in real time and providing and interactive system for promoting such beverages, food, products, and events in real time at a local level. More particularly, the invention relates to a system and method for providing a web and mobile based platform to promote adult or alcoholic beverages, non-alcohol beverages, products & events real-time at a local level.

In other words, the present invention provides for a real time local events and marketing system for managing a plurality of information related to one or more events or products and transmitting at least some of the information to one or more users, said system comprising: at least one server interfaced with a communication network to communicate with a plurality of communication devices associated with said users, a plurality of establishments, a plurality of distributors, and a plurality of marketers, wherein said communication devices are remote from and in communication with said server through said communication network; one or more databases interfaced with said server, wherein at least one of said databases comprises information associated with said establishments, said users, said distributors, said marketers, a plurality of local events, and said products available at said establishment; and at least one application program stored in the memory of said server, said application program being executed by said server to perform the following operations: enable said establishments, said users, said distributors, and said marketers to register, present at least one graphical user interface to said establishments, said users, said distributors, and said marketers, wherein said interface being accessible through at least said application program downloadable onto said communication devices, and through a web browser, utilize an updating system to allow said users, said distributors, said establishments, and said marketers to update information about said local events in said establishments, and said distributors to update information on said products available at said establishments, wherein said marketers can determine based on location of said users, said events at said establishments, and inventory of products to run real time live promotions of said products at said establishments by transmitting specials to said users through said server to the communication device of said users.

The system of the present invention may also include an operation of registration that enables users, distributors, establishments, and marketers to receive an authentication from said server. Another embodiment of the present invention where an operation of utilizing said updating system is further responsive to use of one or more application peripheral interfaces, and one or more event feeds. The invention may also be ability to locate and identify users based on a manual check in by the user through their communication device, or a real time GPS tracking.

The system may also have a communication device that is an individual reception and transmission device configured to allow said users, said establishments, and said marketers to interface with said server. Another embodiment may employ one of the following communication: a mobile phone, a laptop computer, a desktop computer, and a PDA. In an alternative embodiment, the information associated with said users includes a name, an age, a sex, a location, and at least one of said local events received by said server in real time based on the interaction of said users with the system.

The present invention may also be a real time local events and marketing system including at least one server, one or more databases, and at least one application program stored in and to be executed by said server, said application program being configured to: enable a plurality of users to register, present at least one graphical user interface to said users, wherein said interface being accessible through a plurality of communication devices associated with the users, utilize an updating system to allow said users, to update information about a plurality of local events in at least one establishment, and to update information on at least one product available at the establishment, wherein a marketer user can determine based on location of said users, the events at said establishments, and inventory of products at said establishments to run real time live promotions of said product at said establishments by transmitting specials to said users through said server to said communication devices of said users; wherein said server is interfaced with a communication network to communicate with said communication devices remote from and in communication with said server; and wherein said databases are interfaced with said server, at least one of said databases comprises information associated with said establishment, said users, said local events, and said products available at said establishment.

The system may also include an operation of registration that enables said users, to receive an authentication from said server. Additionally, the system's operation of utilizing said updating system may also be further responsive to one or more event feeds. The invention may also be ability to locate and identify users based on a manual check in by the user through their communication device, or a real time GPS tracking. The present invention may also have a system wherein its communication device is a smart mobile phone configured to allow said users to interface with said server.

Additionally, the present invention provides for a method for managing a plurality of information related to one or more events or one or more products and transmitting at least some of the information to one or more users in real-time, said method comprising: Interfacing at least one database with at least one server, wherein the at least one database comprises information associated with said users, at least one establishment, and a plurality of local events, and said products available at said establishments; installing, at least one application program in the memory of said server capable of communicating with a plurality of communication devices associated with said users, said establishments, said distributors, said marketers via a communication network, said application program adapted for performing the following operations: enable said users to register, present at least one graphical user interface to said users, wherein said interface being accessible through said communication devices, and utilize an updating system to allow said users, to update information about said local events in said establishments, and at least one distributor user to update information on said products available at said establishments, wherein at least one marketer user can determine based on location of said users, said events at said establishments, and inventory of products at said establishments to run real time live promotions of said products and said events at said establishments by transmitting specials to said users through said server to said communication device of said users.

This method's utilization of said updating system can be further responsive to use of one or more application peripheral interfaces, and one or more event feeds. Additionally, the method's transmission of said specials may be selective to a subset of users according to one or more selected criteria determined by said marketer user to run real time live promotions of said products at said establishments. Additionally, the information associated with said users may include a name, an age, a sex, and a location received by said server in real time based on the interaction of said users with said establishments. Also, the location of the users may be located and identified based on a real time GPS tracking or user's manually checking in to an establishment using their communication device.

These and other objects, features, and/or advantages may accrue from various aspects of embodiments of the present invention, as described in more detail below.

### BRIEF DESCRIPTION OF THE DRAWINGS

The foregoing summary, as well as the following detailed description of the invention, is better understood when read in conjunction with the appended drawing. For the purpose of illustrating the invention, exemplary constructions of the invention are shown in the drawings. However, the invention is not limited to the specific methods and instrumentalities disclosed herein.

FIG. 1 illustrates a system diagram of the present invention;

### DETAILED DESCRIPTION OF EXEMPLARY EMBODIMENTS

Particular embodiments of the present invention will now be described in greater detail with reference to the figures.

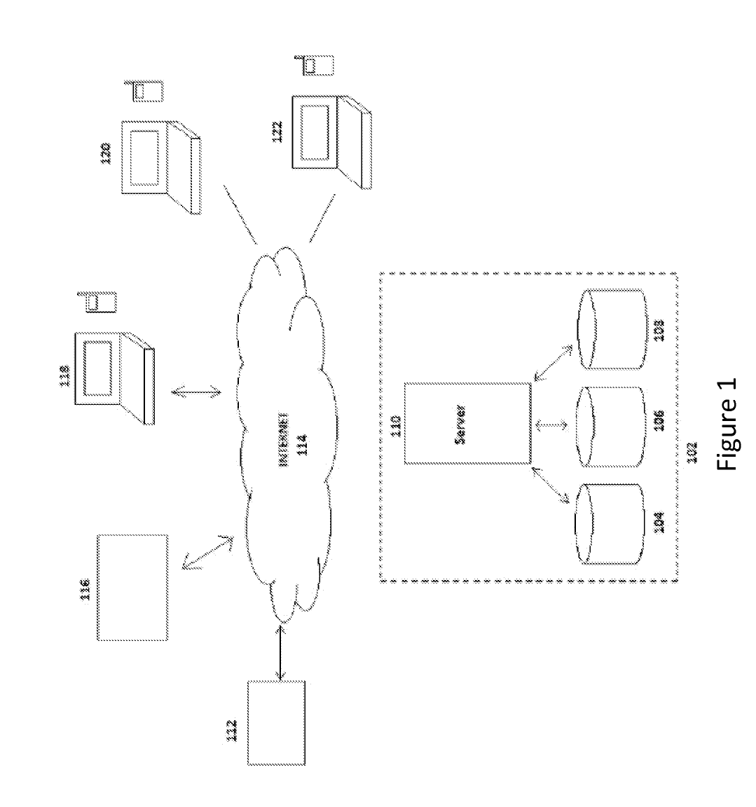

In accordance with FIG. 1, the present invention provides a system for obtaining, transmitting, and receiving data on beverages including wine and alcohol, food, products, and events in real time and promoting, marketing, and advertising specials related to those beverages, food, products, and events in real time.

The present invention provides a system 102 which is comprised of one or more servers 110 connected to one or more databases 104, 106, 108. The databases 104, 106, 108 of the system 102 are comprised of multiple databases, including, but not limited to: (1) one or more databases or tables 104 used to store information related to business profiles of restaurants, bars, music halls, theaters, and other establishments; (2) one or more databases or tables 106 used to store information related to specials, discounts, events, products, by location or zip code; and (3) one or more databases or tables 108 used to store information related to consumers or users visiting the establishments.

Various applications, software, and programs reside on the one or more servers 110 that allow various users to access the system's web interface using their laptop or mobile device 118, 120, 122. User's access the system 102 through the internet 114 or telecommunication network to interact with the systems carious applications and services.

The system organizes the applications and available content on the web interface such that only some applications and content are available to certain users. Thus, some applications and content may be restricted or private, or may only be accessible after the user has been authenticated with a username and password. In the preferred embodiment, all passwords are randomly generated alphanumeric strings of 8-10 characters that are unique to each account holder. However, it should be noted that the system may be designed such that users may create their own unique passwords.

Users may access the system's web interface by using the internet 114 through a computer, mobile device, or smartphone browser, or by downloading a mobile application onto their mobile device. Further, the present invention is primarily utilized by five main types of users: (1) consumers 122; (2) establishments (bars and restaurants) 120; (3) partners, suppliers, and sales representatives (collectively the “Reps”) 118; (4) affiliates 116; and (5) product promoters or advertisers 112.

Partners and sales representatives or Reps 118 interact with establishments 120 on a daily basis. They interact when selling and delivering consumable products such as beer, wine, alcohol, food, and other items pertinent to that establishment 120. The problem is that establishments must constantly update their websites and other social media to inform their customers of specials and events. Further, customers 122 must visit the websites of many establishments to identify specials and events that interest them. What the system of the present invention is able to do is utilize the Reps ordering and delivery systems, or a standalone system, to provide additional information on the products, events, and specials being offered at the establishments. The Reps upon taking or delivering an order enter information about specials and events at each establishment. That information is entered into a standalone application, such as a mobile device application, or entered into applications they already utilize for orders and deliveries. The system 102 of the present invention receives the data from the standalone application, from APIs or feeds of events, or receives data from the already existing applications and culls out the relevant information. Modification of existing ordering or delivery systems would be made to accommodate for the new data fields the Reps are collecting and entering.

The information entered by the Reps or the information from any feeds is then received and processed by the system 102 to create a database of current local events, promotions, specials, inventory, and other information relevant to consumers 122, affiliates 116, and advertisers 112. The information in the database can then be used by one or more websites (i.e. LocalEvents.com or AustinEvents.com) and mobile apps to provide consumers the ability to find current events and promotions. The data can also be accessed and tailored by one or more APIs. By way of example, an establishment could generate a specific feed or tailored API for their events which are then fed back into the establishment's personal website to avoid having to update their website and instead use the benefit of the effort already being performed by the Reps.

Consumers 122 may use the system through one or more websites or mobile applications to search for local events, promotions and specials through the local events application resident on the system 102. The consumer 122 through the website enters his zip code or through GPS tracking of their mobile device identified their location. The system then identifies local events, promotions, and offers in their local based upon information received about each establishment. Consumers 122 may filter the results based on their preferences such as preferred music, beverage, wine, food, and related criteria. The system can utilize push or sync technology with each consumer's mobile device to push promotions and offers to them real time.

By way of example, a consumer 122 looking for live music could use the application of the present invention to identify various establishments 120 with live music that evening. The application might also provide which establishments have specials the consumer might find interesting (such as $1 beers). The consumer might be able to reserve ticket or table or might be able to receive a promotional discount for purchasing a ticket, reserving a table, or confirming their intent to come to the establishment. In addition, the consumer might show at the establishment and use their mobile application to scan a QR code to identify they have arrived at the location. The consumer information is also received by the system 102 and used to provide real time live updates of consumer interaction with the establishments. Such information might include basic profile information of the users such as gender, age, profile picture, and other relevant information. As consumers 122 on a given night interact with the system 102, they can engage the system 102 to see the consumer make up within an establishment. Thus, a group of guys going out for the night could use the system and related application to see that one establishment has higher percentage of females than males based on check ins or reserved spots.

The system 102 can be used by affiliates 116 and advertisers 112 to help advertise, market, and promote products in real time to preferred market segments. By way of example, if an advertiser or promoter 112 is interested in increasing sales of a certain product they could offer incentives to users of the system real time while at the establishment. Still further, if an establishment is noticing light turnout on a particular night and knows that if he can increase the number of females at the bar then more men will also come can offer a special to ladies only (such as $1 drinks for all females). The real time or instant promotion gets pushed to those and helps promote more females to the bar. As more women arrive, the real time system shows more women present thus attracting more men to the establishment.

The system can be used to promote events, a certain drink or meal at the establishment or the establishment itself. National advertisers can use the system to promote new product launches. By way of example, Red Bull could be advertising a new product and wants to market their new beverage to everyone in a certain locality. They can use the system 102, to select certain establishments, consumer profiles (gender, age), and restrictions (time, price) and offer specials (i.e. $1 Red Bull—new flavor and vodka drinks from 10-11 pm).

By using the system of the present invention, real time data on events, product inventory, and consumers can be used to improve the promotion, advertising, and sales of products and the establishments selling those products. Further, as historical data is analyzed, the system is able to identify trends which are most profitable for the establishments, attract the desired consumers, or provide the best branding opportunity for national and local advertisers.

The system is particularly useful for promoting and marketing brand specific drink specials details like $1 beers, $5 wine, ½ bottles wine, and the like all at the local level and in real time. Such system is great for brand specific promotional events (i.e. Summer Nights with Summer Whites wine Event) and new BRAND launches!

The system would provide detailed information on an Account such as a bars, restaurants, clubs, grocery store, golf course, hotels, or the like. All information related to that Account would be secured and updated including: Live Music and/or Concert information; Coupons for Products & events; Location to download information and coupons through website or app; Local promotional info at account level; Names and information of employees at accounts (Managers, Owners, Servers, Etc.); Consumer Comments, Ratings and Blogs. (Like Yelp); Live attendance information (i.e. Male/Female, # of People, Comments, Customer Profiles-Likes, dislikes, etc.).

In addition, the system would have or could employ the use of: locations of wine tastings nationally; QR CODES; Accounts would be mapped within a GPS enable website or mobile application; a “Smart Phone” application for real time information at a local level; and would be able to provide details on products and the company backgrounds of those products (i.e. Suppliers, History of products, Wine Maker Names, locations of wineries).

The system would be able to provide benefits to users and information providers. Such opportunities might include an opportunity to get on the VIPList for major events & venues. Such perks might include: Front rows of Concerts; No Lines for Bars & Clubs; VIP sections in Bars & Clubs; Special Tables at high profile restaurants; No reservations needed; Invites to VIP events closed to public (i.e. Charity events, Movie Premiers, Club/Bar Openings, Celebrity Parties, etc.)

The system would allow the entry and receipt of real time data from supporting partners at each individual account. As the partner sales representative calls on a specific account, they would ask a list of questions related to local events, specials, promotions and the like. The answers to all questions would be transmitted with the representative's order. Information would be compiled and transmitted to the servers 110 and databases 104, 106, 108 of the system 102.

The site would be populated with real-time data information submitted as well as information from many other partners & providers. The system provides an opportunity for all levels of the beverage or Product (Supplier-Brands, Distributor, Customer & entertainment industry (Bar, Restaurant, Club, Hotel, etc.) to grow share and promote their global products at an extremely local level while also having the availability to have a national/global reach in “REAL-TIME”.

A brand could have a local program promoted at ONE account or a chain of accounts or on Friday night at every bar, club, restaurant &/or concert in the United States or World. An opportunity to co-sponsor events at a national level (Country Music bars/concerts tie-in with complementary national brand).

The system also allows for single location branding including branded websites for online customers to get the “REAL” true information they desire. (Drink Specials, Updated Account Information).

An opportunity for a select local establishment to get noticed and compete with competitors by providing specials, or being highlighted on the website, customer interaction-ratings, or other events and efforts.

Provides national marketing opportunities to get brand/message “Flashed” across the United States very quickly and easily in real time.

The system provides a REALIABLE website (and mobile application) with incredibly valuable information for the website consumer. It can be used as a tool to identify where people can meet and become friends.

The system makes use of various data feeds and API's, websites, and other tools (GPS mapping) to provide a fully integrated and real time system. Feeds might include feeds from Distributor and Customer Data feeds such as Beer, Wine, Spirits & Non Alcohol, All National & Local Accounts—On & Off Premise, Live Nation/Ticketmaster, City Websites-Chicago.com, NYC.com and the like.

The system would incorporate various solutions including mobile management, local and direct marketing, API's and partnerships and could tie into various other networks such as Facebook, Google, Pintrest, twitter, and other relevant services.

The examples provided herein are merely for the purpose of explanation and are in no way to be construed as limiting of the present method and product disclosed herein. While the invention has been described with reference to various embodiments, it is understood that the words which have been used herein are words of description and illustration, rather than words of limitation. Further, although the invention has been described herein with reference to particular means, materials, and embodiments, the invention is not intended to be limited to the particulars disclosed herein; rather, the invention expands to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

It will be recognized by those skilled in the art that changes or modifications may be made to the above described embodiment without departing from the broad inventive concepts of the invention. It is understood therefore that the invention is not limited to the particular embodiment which is described, but is intended to cover all modifications and changes within the scope and spirit of the invention.

What is claimed is:

1. A real time local events and marketing system for managing a plurality of information related to one or more events or products and transmitting at least some of the information to one or more users, said system comprising:
at least one server interfaced with a communication network to communicate with a plurality of communication devices associated with said users, a plurality of establishments, a plurality of distributors, and a plurality of marketers, wherein said communication devices are remote from and in communication with said server through said communication network;
one or more databases interfaced with said server, wherein at least one of said databases comprises information associated with said establishments, said users, said distributors, said marketers, a plurality of local events, and said products available at said establishment; and
at least one application program stored in the memory of said server, said application program being executed by said server to perform the following operations:
enable said establishments, said users, said distributors, and said marketers to register,
present at least one graphical user interface to said establishments, said users, said distributors, and said marketers, wherein said interface being accessible through at least said application program downloadable onto said communication devices, and through a web browser,
utilize an updating system to allow said users, said distributors, said establishments, and said marketers to update information about said local events in said establishments, and said distributors to update information on said products available at said establishments, wherein said marketers can determine based on location of said users, said events at said establishments, and inventory of products to run real time live promotions of said products at said establishments by transmitting specials to said users through said server to the communication device of said users.

2. The system of claim 1, wherein said operation of registration enables said users, said distributors, said establishments, and said marketers to receive an authentication from said server.

3. The system of claim 1, wherein said operation of utilizing said updating system is further responsive to use of one or more application peripheral interfaces, and one or more event feeds.

4. The system of claim 1, wherein the location of said users is identified based on a manual check in by the user through their communication device.

5. The system of claim 1, wherein said location of said users is identified based on a real time GPS tracking.

6. The system of claim 1, wherein said communication device is an individual reception and transmission device configured to allow said users, said establishments, and said marketers to interface with said server.

7. The system of claim 1, wherein said communication devices comprises one of: a mobile phone, a laptop computer, a desktop computer, and a PDA.

8. The system of claim 1, wherein said information associated with said users includes a name, an age, a sex, a location, and at least one of said local events received by said server in real time based on the interaction of said users with the system.

9. A real time local events and marketing system including at least one server, one or more databases, and at least one application program stored in and to be executed by said server, said application program being configured to:
enable a plurality of users to register,
present at least one graphical user interface to said users, wherein said interface being accessible through a plurality of communication devices associated with the users,
utilize an updating system to allow said users, to update information about a plurality of local events in at least one establishment, and to update information on at least one product available at the establishment, wherein a marketer user can determine based on location of said users, the events at said establishments, and inventory of products at said establishments to run real time live promotions of said product at said establishments by transmitting specials to said users through said server to said communication devices of said users;
wherein said server is interfaced with a communication network to communicate with said communication devices remote from and in communication with said server; and
wherein said databases are interfaced with said server, at least one of said databases comprises information associated with said establishment, said users, said local events, and said products available at said establishment.

10. The system of claim 9, wherein said operation of registration enables said users, to receive an authentication from said server.

11. The system of claim 9, wherein said operation of utilizing said updating system is further responsive to one or more event feeds.

12. The system of claim 9, wherein said location of said users is identified based a real time GPS tracking.

13. The system of claim 9, wherein said location of said users is identified based on said user manually checking in to an establishment using their communication device.

14. The system of claim 9, wherein said communication device is a smart mobile phone configured to allow said users to interface with said server.

15. A method for managing a plurality of information related to one or more events or one or more products and transmitting at least some of the information to one or more users in real-time, said method comprising:
Interfacing at least one database with at least one server, wherein the at least one database comprises information associated with said users, at least one establishment, and a plurality of local events, and said products available at said establishments;
installing, at least one application program in the memory of said server capable of communicating with a plurality of communication devices associated with said users, said establishments, said distributors, said marketers via a communication network, said application program adapted for performing the following operations:
enable said users to register,
present at least one graphical user interface to said users, wherein said interface being accessible through said communication devices, and
utilize an updating system to allow said users, to update information about said local events in said establishments, and at least one distributor user to update information on said products available at said establishments, wherein at least one marketer user can determine based on location of said users, said events at said establishments, and inventory of products at said establishments to run real time live promotions of said products and said events at said establishments by transmitting specials to said users through said server to said communication device of said users.

16. The method of claim 15, wherein said utilization of said updating system is further responsive to use of one or more application peripheral interfaces, and one or more event feeds.

17. The method of claim 15, wherein said transmission of said specials is selective to a subset of users according to one or more selected criteria determined by said marketer user to run real time live promotions of said products at said establishments.

18. The method of claim 15, wherein said information associated with said users includes a name, an age, a sex, and a location received by said server in real time based on the interaction of said users with said establishments.

19. The method of claim 15, wherein said location of said users is identified based on a real time GPS tracking.

20. The method of claim 15, wherein said location of said users is identified based on said user manually checking in to an establishment using their communication device.
